(19) United States
(12) Patent Application Publication
(10) Pub. No.: US 2009/0067174 A1
(43) Pub. Date: Mar. 12, 2009

(54) MULTI-FUNCTION LIGHTING AND WARNING MOSQUITO EXPELLER

(75) Inventors: FU-JEN KAO, TAIPEI (TW); CHENG-CHUN LI, TAIPEI (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL YANG-MING UNIVERSITY, TAIPEI CITY (TW)

(21) Appl. No.: 12/199,936

(22) Filed: Aug. 28, 2008

(30) Foreign Application Priority Data
Sep. 6, 2007 (TW) 096214913

(51) Int. Cl. F21V 33/00

(52) U.S. Cl. 362/253

(57) ABSTRACT

The present creation relates to a method and a device for multi-function lighting and warning mosquito expeller.

### FIELD OF THE INVENTION

The present invention relates to a device for multi-function lighting and warning mosquito expeller. Particularly, the present invention makes use of LED display to emit different color, different wavelength or glittering frequency to expel mosquitoes.

### DESCRIPTION OF PRIOR ART

The conventionally used mosquito expelling devices adopted mosquito coils, mosquito incense, as to the invention of electronic mosquito repeller and mosquito repellent vaporizer nowadays. For the convenience of using them inside the house, the expeller of the chrysanthemum essence which has low toxicity among humans serves as the drug, but the drawback is that the effects last about 4-5 hours and eventually the pesticide evaporates out, which poses a time limit. Furthermore, the odor produced when burning chemically synthesized drug stimulates the airway or mucous tissues of human beings, while the spray pesticide has the following disadvantages: cannot spray at fire or the source of electricity, can damage human bodies due to chemical toxicity as well, and has to be kept in cool and shady place where kids have no access, in case accidents should happen.

To avoid the harm of chemical drugs, there are inventions such as electrical mosquito trapper, electrical mosquito swatter, etc. that, though convenient to use, since it utilizes the conducting of high voltage current to kill the mosquitoes, it requires to do is turning it on in the dark or trace the mosquitoes with the swap when they show up without worrying about the side effects of the drugs on human bodies. In addition, there have the drawback as follows:

The sound of shock is too loud, the loudness of the sound, despite short, deteriorate sleep quality if already asleep at night; it smells, the burning smell after electrical shock is unbearable; people might get hurt, especially children if they touch it by accident, or if the electricity leaks; it consumes much electricity, the instant of shock requires high voltage and thus consumes much electricity, as a result constant recharging is necessary; the remains of the insects flow in the air, the mosquito explodes when shocked, and many germs, its remains and body fluids flying around and are breathed in through people's airways or ingested with food; also the electrical mosquito trapper or electrical mosquito swatter take up some space and are meant to use indoors, not to carry around. The evolving of mosquito expelling methods mentioned above shows that, to deal with the annoying mosquitoes, we need a method that is efficient, safe, long-lasting and environment protecting.

### BRIEF DESCRIPTION OF THE DRAWINGS

FIG. 1 is the first exemplified figure of the invention of the multi-function lighting and warning mosquito expeller.

FIG. 2 is the first exemplified figure of the invention of the multi-function lighting and warning mosquito expeller, including FIG. 2A of the front view and FIG. 2B of the side view.

### SUMMARY OF THE INVENTION

This invention provides a multi-function lighting and warning mosquito expeller comprising: a LED, which is used to provide lights and, an expelling circuit, which causes the LED to show lights of various colors, wavelengths and glittering frequencies.

### DETAILED DESCRIPTION OF THE INVENTION

According to the conventional techniques previously described in description of prior art, using chemical drugs or burning mosquito coils to expel bugs, will damage human bodies and the limit period of effectiveness, while using electrical mosquito trapper or electrical mosquito swatter has the problem of wasting electricity, producing foul smells, spreading diseases and inconvenience to carry around. In view of the above, the invention provides a device for multi-function lighting and warning mosquito expeller to solve said problems.

The invention provides a light-structured, easy-to-use multi-function lighting and warning mosquito expeller 10 combining a expelling circuit 50 and LED 20. The invention overcomes the problems of burning odors and harmful chemicals of mosquito coils or chamomile essential oil on the market after burning that irritate the airway. In addition, because there is no need to transform from heat energy to light energy, it is more power-economic and long lasting. Furthermore, the LED is not easily damaged, does not produce foul gas, which fulfill the need of practical use and environmental conservation. When the Led is combined with the expelling circuit, a power-economic, multi-function lighting and long lasting, easy-to-carry mosquito expelling device 10 is obtained. Besides, the high intensity light emitted from the LED can be used in combination with highly-permeable, scattering lamp case 30 so the light becomes scattered after passing through the case and sends uniformly to all directions, or be used alone so the light is parallel, with high intensity of illumination.

To accomplish the objectives mentioned above, the invention provides a multi-function lighting and warning mosquito expeller 10 comprising:

a LED 20, the LED shows lights of various colors, wavelengths and glittering frequencies, depending on the electrical conductivity; and a expelling circuit 50; the expelling circuit 50 is electrically connected to the LED 20 and, through regulating the expelling circuit 50, the LED 20 can have a variety of lighting effects, producing lights with expelling effects for bugs of different biological characteristics.

In the invention of the multi-function lighting and warning mosquito expeller 10 the expelling circuit can be further set to a glittering circuit so that the LED 20 produces constant lights or lights of different glittering frequencies.

In the invention of the multi-function lighting and warning mosquito expeller 10, the lights issued from the LED 20 can be short-wave lights such as violet, blue or ultraviolet, or the ones that bugs dislike.

The invention of the multi-function lighting and warning mosquito expeller can further include an audio frequency simulating module 40, which mimics the frequency of the wing flapping of male mosquitoes and disturbs the hearing system of female mosquitoes to achieve the expelling mosquito effects.

The invention of the multi-function lighting and warning mosquito expeller can further comprises an ultrasound device, which sends out various audio frequencies and the low frequency ones interfere with mosquitoes and keep them away. The invention of the multi-function lighting and warning mosquito expeller can further comprises an ultrasound device which produces high frequency sounds that cause water molecules to collide in high velocity and to vaporize quickly, so that the anti-mosquito spray, insects repellent and chamomile essential oil etc. can evaporate without burning them, which saves power and avoids damaging human health.

The invention of the multi-function lighting and warning mosquito expeller can be attached to the side of a cell phone and electrically connected to the expelling circuit via the battery of the cell phone. The expelling circuit then makes the LED of the cell phone to show lights of various colors, wavelengths and glittering frequencies; the LED also has the function of illuminating, and is easy to carry since it is attached to the cell phone.

### EXAMPLE

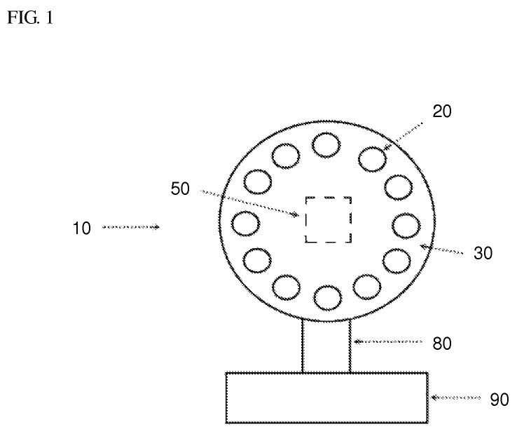

Please refer to FIG. 1, to achieve the effects of illuminating and mosquito expelling, the invention of the multi-function lighting and warning mosquito expeller 10 comprises a LED 20 and an expelling circuit 50. The expelling circuit 50 and the LED 20 were electrically connected, in which the LED 20 showed lights of various colors, wavelengths and glittering frequencies controlled by the expelling circuit 50. The LED 20 was more power-economic, durable than conventional incandescent lamp and endured damages even in rough situations. In addition, it was small and could achieve long, stable mosquito expelling effects without causing harm to human health, and the LED 20 could also be used together with highly-permeable, scattering lamp case 30.

The expelling circuit 50 used in the invention could be glittering circuit which controlled the glittering frequency of the LED 20 light, and the patterns of glittering were unbearable to mosquitoes and bugs. The glittering lights of the LED 20 could be short-wave lights such as blue, violet or the ones that bugs dislike. Furthermore, because bugs favored dark and shady environments, the illuminating of high intensity LED also kept them from approaching. The invention further comprised a connecting pole 80 and a pedestal 90, to stand on a flat surface and be used properly.

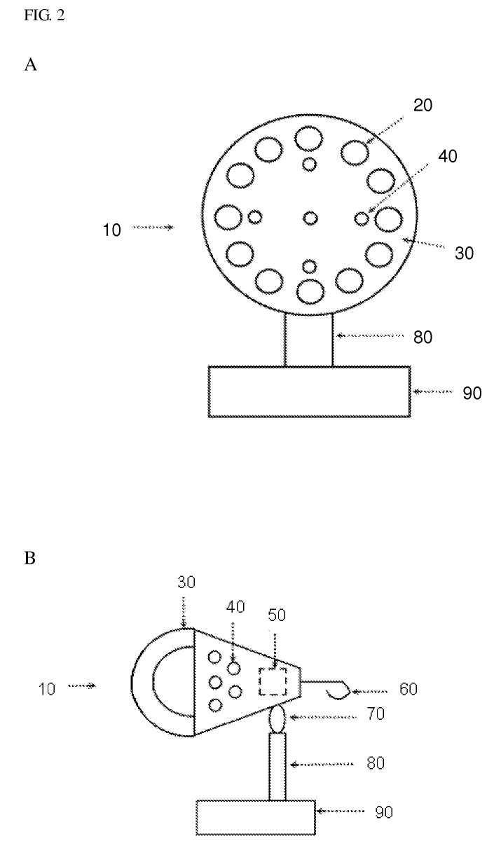

As illustrated in FIG. 2, in the invention of the multi-function lighting and warning mosquito expeller 10, apart from the basic LEC 20, expelling circuit 50, the highly-permeable, scattering lamp case 30, the connection pole 80 and the pedestal 90, an audio frequency simulating module 40 was further installed to mimic the frequency of the wing flapping of male mosquitoes. Because only the female mosquitoes sucked human blood, and because they needed a lot of nutrient to successfully ovulate and reproduce in pregnancy and would not mate with male mosquitoes for it could affect the reproduction and even have life-threatening risks, the rationale was thus used to achieve mosquito expelling effect by mimicking the frequency of the wing flapping of male mosquitoes to interfere with the hearing system of female mosquitoes. Besides, for the convenience of using, a hanging hook 60 and a removable rotating hinge 70 were included, so that the invention could be hanged over a height in addition to placing on a flat surface.

While the invention has been described and exemplified in sufficient detail for those skilled in this art to make and use it, various alternatives, modifications, and improvements should be apparent without departing from the spirit and scope of the invention.

What is claimed is:

1. A multi-function lighting and warning mosquito expeller comprising:
a LED, which is used to provide lights and,
an expelling circuit, which causes the LED to show lights of various colors, wavelengths and glittering frequencies.

2. The multi-function lighting and warning mosquito expeller according to claim 1, wherein the expelling circuit is a glittering circuit which controls the LED to produce light of different glittering frequencies.

3. The multi-function lighting and warning mosquito expeller according to claim 1, wherein the light from the LED is violet light, blue light, ultraviolet light, or the light that bugs dislike.

4. The multi-function lighting and warning mosquito expeller according to claim 1, further comprising an audio frequency simulating module to mimic the frequency of the wing flapping of male mosquitoes to keep the female ones away.

5. The multi-function lighting and warning mosquito expeller according to claim 1, further comprising an ultrasound device which produces low frequency sounds to expel mosquitoes.

6. The multi-function lighting and warning mosquito expeller according to claim 1, further comprising an ultrasound device which produces high frequency sounds to evaporate the anti-mosquito spray or mosquito repellent.

7. The multi-function lighting and warning mosquito expeller according to claim 1, which attached to a cell phone and utilizes the LED and the power of the battery of the cell phone to expel mosquitoes.
